(19) United States
(12) Patent Application Publication
(10) Pub. No.: US 2014/0138396 A1
(43) Pub. Date: May 22, 2014

(54) INFANT BOTTLE HOLDER

(71) Applicant: CAROL ALTERMATT, North Branford, CT (US)

(72) Inventor: CAROL ALTERMATT, North Branford, CT (US)

(21) Appl. No.: 14/082,159

(22) Filed: Nov. 17, 2013

Related U.S. Application Data
(60) Provisional application No. 61/728,866, filed on Nov. 21, 2012.

(51) Int. Cl. A61J 9/06

(52) U.S. Cl. CPC A61J 9/06
USPC 220/737

(57) ABSTRACT

An infant bottle holder for infants under the age of one year of age comprising a central sleeve and one or more protrusion. Said protrusion having ergonomic features that assist an infant at a young age to grasp or leverage said bottle within said bottle holder to independently feed. Said infant bottle holder for infants under age of one year of age further having multisensory features that stimulates and encourages mental emotional development.

### CROSS REFERENCES

This non-provisional patent application claims benefit of said copending provisional patent application, Application No. 61/728,866, effectively filed on Nov. 21, 2012, pursuant to 35 U.S.C. 119(e) and 37 C.F.R. 1.78 (a)(4)-(a)(6) and all other relevant sections of the law not referred to herein.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

1. Field of the Invention

The present invention relates to an infant bottle. More particularly, the present invention pertains to a bottle holding apparatus for an infant or small child.

2. BACKGROUND

Infants and small children generally consume beverages and other types of fluids from a baby bottle. A standard commercially produced baby bottle typically comprises a bottle of a given length and diameter capable of holding fluids in volumes of three ounces to 18 ounces. The range of volume typically reflects the standard feeding demand of an infant at a given age. The typical age by which infants begin bottle feeding, that is, feeding from a baby bottle as oppose to breast feeding, can begin as early as the initial weeks to month after birth. Bottle feeding typically tapers off and end between one to two years of age as the child transitions to solid food. As such, commercially produced bottle sizes tend to naturally be standard in nature to adequately satisfy the process involved.

There are many inherent challenges related to bottle feeding a young infant or baby. The activity seems deceivingly straight forward but is in fact multifaceted and challenging. The feeding process is intended not only for the purpose of nourishing the baby, but further to sooth and satisfy the baby emotionally, calm the baby to sleep, provide a sense of security through predictability, and to encourage mental-emotional connection between the baby and those things or people in her direct physical contact. At the early stage when the infant is not self mobile, moments when she receives the greatest amount of mental and emotional stimulus for a good duration is typically during feeding time. As such, amplifying the effect of certain desired interactions between the baby and its environment during feeding time is ideal for optimum development at this early stage.

At an early stage, the healthy mental and emotional development of an infant would require some amount of independent play and soothing time. Whereas a mother who breastfeeds must commit an amount of time to feed, play and sooth the baby, the bottle fed baby would not be as dependent on her mother's immediate direct physical presence to satisfy such needs. A bottle fed baby may be encouraged to become more autonomous with her feeding routine and activities at an earlier stage with tools that help her learn to hold onto, feed from and play with a bottle during the entire soothing, feeding and sleeping process. This stage of development is beneficial also for the caregiver, freeing up time and physical demands to multitask other responsibilities. It is at this crucial stage of infant development that many bottles and bottle holders fail to address the above listed needs and challenges effectively. The continuing problem remains in the difficulty for a small infant to be able to maintain the bottle in position during and throughout the entire feeding process.

Baby bottles by design are inherently not intended to be grasped by an infant whose tactile control has not yet begin to mature. At this early stage, typically near five months of age, the baby's hand and finger coordination is directed by more primal instincts, either curled up tight or else balled together in a tight fist. It would be near impossible for an infant at this early age to securely hold onto a standard baby bottle for more than a mere moment or longer. For this reason, infant bottle holders were developed to provide assistance in autonomous bottle feeding for babies.

U.S. Pat. Nos. 5,072,843, 6,523,792, 6,824,112, 6,827,317, 5,217,192 and PCT/IL2009/000711. provides a plush bottle holder intended to enable an infant to grasp the bottle via the bottle holder for self feeding. These inventions are all inherently flawed because they provide a plush holder with shape and size that are equally wide and broad, if not more so, than that of the bottle itself. The soft plush nature of holder may be aesthetically pleasing, but certainly falls short in enabling a young infant to securely grasp the taught fabric that is filled with batting material, made further taught by the bottle held within.

Despite the well intention of the existing art to address this need, their claimed features and designs pose the same challenges that exist with the bottle, providing no real improved method or mechanism for a young infant to naturally hold onto a bottle for a sustainable amount of time. Other developmental needs associated with the feeding process described above are also overlooked in these patent disclosures and claims. Overall, the current art does not provide for a bottle holder that achieves the multifaceted development effects discussed above.

### SUMMARY OF INVENTION

The present invention overcomes these problems with a bottle holding apparatus for an infant or small child. The device comprises a central sleeve 101 portion attached to one or more protrusion 102a,b. See FIG. 1. The central sleeve portion 101 having a length, a width, a top end 103 that is open, and a bottom end 104. See FIG. 1. The open end 201 of said central sleeve 202 should be wide enough to accept and snuggly hold a standard sized infant bottle. See FIG. 2. Additional features may be added to the central sleeve, such as a cinching mechanism 203, FIG. 2, around the open edge, to maintain said bottle within the sleeve during use. The length of the central sleeve portion is also preferably equal to or less than the length of a standard infant nursing bottle.

Each protrusion 102 a,b, FIG. 1, should comprise a length of material that extends outwardly from said central sleeve portion. Each protrusion 102 a,b is connected to said central sleeve portion from at least one location 105 along its length. See FIG. 1. Each protrusion 102 a,b having a width or diameter 106 that is within the size of a standard grip of a young infant's hand who is under one year of age. See FIG. 1. The size of said protrusion 102 a,b in terms of its width or diameter 106 may have a variation of range depending on the standard grip of a young infant of a given age. See FIG. 1. Said protrusion 102 a,b, FIG. 1, may be surrounded by open space sufficient for an infant's fingers to wrap around the width or diameter of each said protrusion. The open space between said protrusion and central sleeve may alternatively be interconnected by solid material 107, FIG. 1, such as rubber, fabric or netting material to create a wing like effect against which the infant may leverage her fist against in an upward manner. Said central sleeve 101, FIG. 1, portion further contains a musical element (not shown in the illustration), a sound emitting element (not shown in the illustration) or a light emitting element (not shown in the illustration) to create an interactive multisensory environment.

The material of the device may comprise but is not limited to any of the following or combination of the following: fabric, nylon, rubber, latex, neoprene, elastic polymers, plastic, wood etc. Ideally, the material should be washable, free of toxic chemicals or dyes such as bpa's (bisphenol A), and optionally microwave safe. Alternatively, the material composition may take on a soft plush affect similar to a stuffed toy. The method of manufacturing said device would depend on the materials used, which may include but would not be limited to sewing, stitching, injection molding, die cutting, or any combination of these methods. In any case, the sound and light emitting element, which typically relies on a battery source, is preferably a separate self contained component that is detachable to enable ease of wash.

The protrusion 102 a,b, FIG. 1, itself may take on a variety of forms and designs. The ultimate purpose is to provide an aesthetically pleasing and ergonomically functional handle by which a young infant may grasp or leverage her fists against. Preferably a plurality of protrusions 102 a,b, FIG. 1, should be available within reach of the infant's grasp to allow instincts to dictate since conscious coordination is not yet fully developed at an early age. As such, the pattern of protrusion around the central sleeve 101, FIG. 1, becomes important from an ergonomic point of view. One preferred method of arranging the protrusion around the bottle is to have several lengths of protrusions connected to one end of the central sleeve extend and connect to an opposite end of the central sleeve. This would result in a curved handle lengthwise along the central sleeve and bottle. The space between the protrusion and the central sleeve may optionally be interconnected with thin material 107 to create a wing-like effect. See FIG. 1. The infant may grasp the thin ends 106 of the wing where the length of said protrusion 102 a,b creates the wing's exposed edge. See FIG. 1. Alternatively, the protrusions may extend from one end connection point with the central sleeve and travel along the length and circumference of the central sleeve in a spiraling manner. The space between the protrusion and central sleeve may or may not be interconnected with material. In any case, the spiraling effect provides ample handle locations along the length of the bottle proximate to the infant's instinctive grasp. Yet another embodiment of this invention provides for a layered ring effect along the length of the central sleeve. A plurality of protrusions would encircle the central sleeve in horizontal layers along the vertical length of the central sleeve. This also provides ample handles proximate to the infant's instinctive grasp. Lastly, another embodiment of this invention provides for a plurality of protrusions that mimic follicle—like extensions throughout the central sleeve surface. This provides tactile stimulation to the infant while providing ample handles for ease of grip.

The protrusion 102 a,b, FIG. 1, is available on one or more sides of the sleeve body to provide a handle or leverage effect such that the infant can maintain the bottle above its face and mouth for the duration of feeding. The infant's curled fist may be leveraged under the protrusion on either side of the bottle, suspending it in midair, or else reflexively grasping the protrusion that is designed to fit into the small palms of her hands. The base of the body 104, 301 (see FIGS. 1 and 3) additionally includes a loop 302, FIG. 3, or similar accessory that can be used for attachment of a pacifier. The device enables an infant or small child to grasp the handles 401 for feeding himself or herself, and additionally provides musical entertainment (not shown in the illustration), and a location for attachment 302, FIG. 3.

### BRIEF DESCRIPTION OF DRAWINGS

FIG. 1 demonstrates a front side view of the invention according to a preferred embodiment thereof.

FIG. 2 demonstrates a top view of the invention according to a preferred embodiment thereof.

FIG. 3 demonstrates a bottom view of the invention according to a preferred embodiment thereof.

FIG. 4 demonstrates a front side view of the invention according to a preferred embodiment thereof.

### DETAILED DESCRIPTION

Reference will now be made in detail to exemplary aspects of the present invention. Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

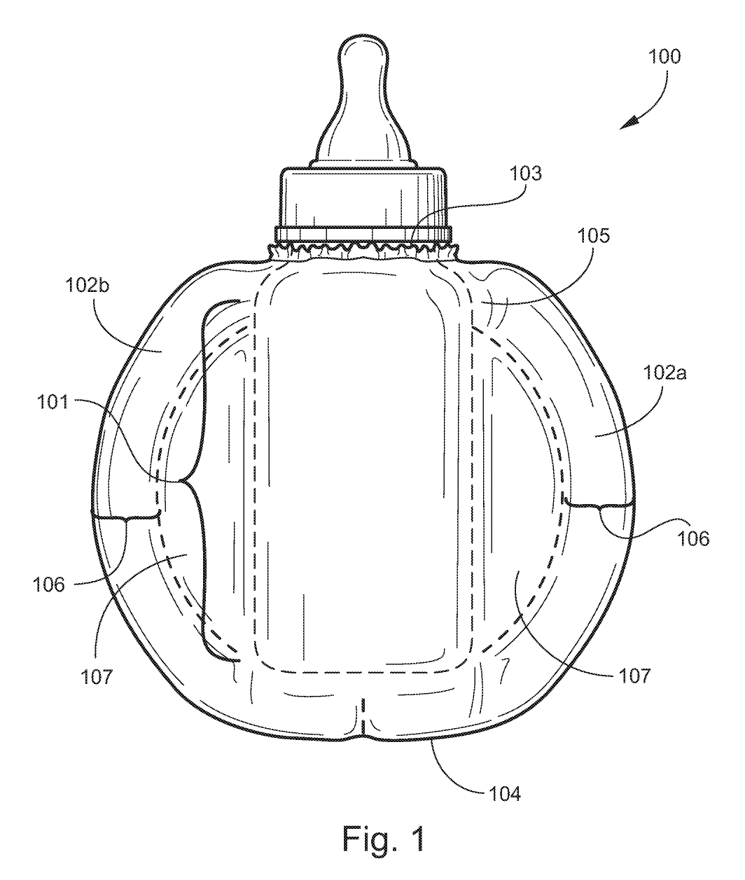

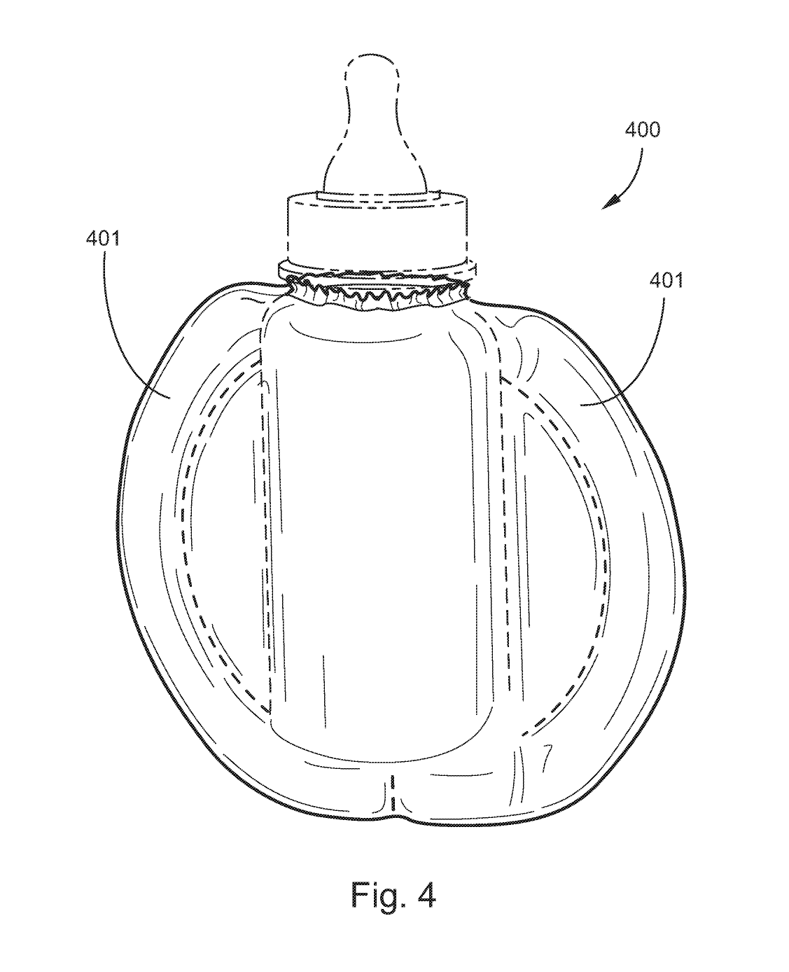

FIG. 1 is a front side illustration of the invented device 100 comprising two protrusions 102 a,b extending from a central sleeve 101. Each protrusion connecting at the top 103, 105 and bottom end 104 of said central sleeve 101. See FIG. 1. Each protrusion 102 a,b is interconnected with the central sleeve 101 with a fabric material 107 to create a wing like handle feature. See FIG. 1. The embodiment herein provides for a plush fabric style design that is sewn and stitched together. Alternative materials and methods of manufacturing, such as injection molding with neoprene material is also contemplated although not shown in the illustrations provided. The protrusion 102 a,b, 106 illustrated in this embodiment having a round quality with a diameter 106 of approximately half an inch. See FIG. 1. FIG. 1 illustrates a more basic embodiment of the invention, which does not include any attachments or audio visual options. FIG. 4 is a side perspective view of the invented device 400 as illustrated above in FIGS. 1.

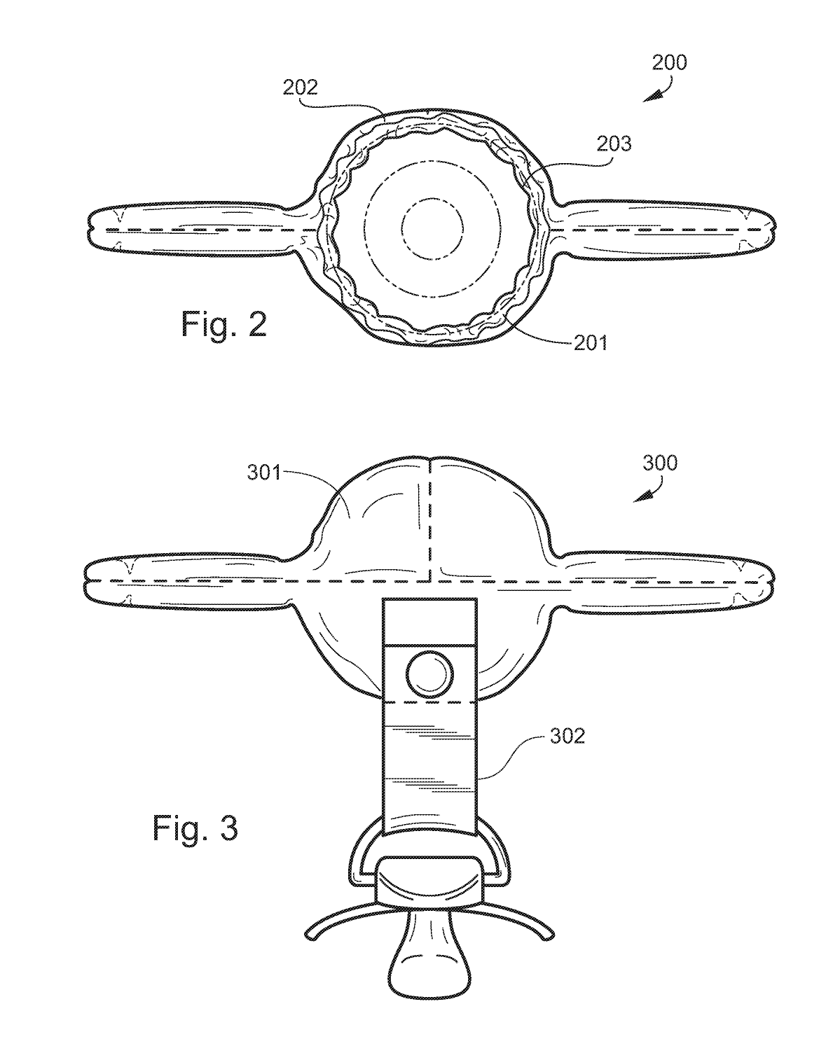

FIG. 2 is a top perspective view of the invented device 200 demonstrating the top opening 202 intended to receive a standard sized infant bottle. The embodiment herein provides for a cinching feature 203 around the edge of said opening to keep the bottle in place. See FIG. 2. However, known alternative methods in the field for maintaining the bottle in place is also within contemplation of the art herein.

FIG. 3 is a bottom perspective view of the invented device 300 demonstrating an alternative embodiment with a loop attachment 302 that connects to a pacifier or similar teething or soothing device. See FIG. 3. The intention is to provide dual option for meeting an infant's oral soothing fixation with either a feeding bottle or a chew toy in one unitary device.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Having fully described at least one embodiment of the present invention, other equivalent or alternative devices will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

I claim a:

1. An infant nursing bottle holder comprising:
A central sleeve portion, said central sleeve portion further comprised of a length, a width, a top end that is open, and a bottom end;
Said central sleeve portion attached to one or more protrusions, each said protrusion having a length that extends outwardly from said central sleeve portion;
Said protrusion connected to said central sleeve portion from at least one location along its length;
Said protrusion having a width or diameter within the standard grip of a young infant's hand under one year of age;
Said protrusion surrounded by open space sufficient for an infant's fingers to wrap around the width or diameter of each said protrusion;

2. Said infant nursing bottle holder of claim 1 wherein one or more of said protrusions extending vertically between the top end and bottom end along the length of said central sleeve portion.

3. Said infant nursing bottle holder of claim 1 wherein one or more of said protrusions extending vertically between the top end and bottom end along the length of said central sleeve portion in an arched manner.

4. Said infant nursing bottle holder of claim 1 wherein one or more of said protrusions extending between the top end and bottom end along the length of said central sleeve portion in a spiraling manner.

5. Said infant nursing bottle holder of claim 1 wherein one or more of said protrusions extending horizontally and wrapping around the circumference of said central sleeve portion, each protrusion connecting to said central sleeve at one or more locations along its length.

6. Said infant nursing bottle holder of claim 1 wherein one or more of said protrusions extending from the exposed surface of said central sleeve, each said protrusion comprising a first end and a second end, said first end connected to said central sleeve portion and said second end exposed and unattached.

7. The space between said protrusion and said central sleeve portion of claim 1 further interconnected by fabric or netting material to create a wing like effect.

8. The infant bottle holder of claim 1 containing a musical or sound emitting element.

9. The infant bottle holder of claim 1 containing a light emitting element.

10. An infant nursing bottle holder comprising a central sleeve portion, said central sleeve portion further comprised of a length, a width, a top end that is open, and a bottom end, said central sleeve portion attached to one or more protrusions, each said protrusion having a length that extends outwardly from said central sleeve portion, said protrusion connected to said central sleeve portion from at least one location along its length, said protrusion having a width or diameter within the standard grip of a young infant's hand under one year of age, said protrusion surrounded by open space sufficient for an infant's fingers to wrap around the width or diameter of each said protrusion, said open space between said protrusion and central sleeve further interconnected by fabric or netting material to create a wing like effect, said central sleeve portion containing a musical element, a sound emitting element or a light emitting element.
